(19) United States
(12) Patent Application Publication
(10) Pub. No.: US 2010/0205060 A1
(43) Pub. Date: Aug. 12, 2010

(54) CONTEXT-SENSITIVE ROUTE GENERATION SYSTEM

(75) Inventors: Athellina Athsani, San Jose, CA (US); Elizabeth F. Churchill, San Francisco, CA (US)

Correspondence Address: MARTINE PENILLA & GENCARELLA, LLP, 710 LAKEWAY DRIVE, SUITE 200, SUNNYVALE, CA, 94085, US

(73) Assignee: Yahoo! Inc., Sunnyvale, CA (US)

(21) Appl. No.: 12/368,195

(22) Filed: Feb. 9, 2009

(51) Int. Cl. G01C 21/36; G06Q 30/00

(52) U.S. Cl. 705/14.58; 701/200; 701/210; 701/209

(57) ABSTRACT

Embodiments of the present invention describe systems and methods for automatically generating route(s) based on users' trip intent and conditions. A user enters his/her trip intent and conditions. A context-sensitive route generation system generates one or more routes based on information surrounding the user's trip intent, such as destination, time, means of transportation, purpose and identity(ies) of traveler(s), and conditions, such as user's limitations, needs, and preferences, for the user. Once the user chooses a route to follow, context-sensitive route generation system (CRGS) keeps track of user's movement and can modify the user's route when a need arises. The CRGS searches one or more networks and the system database(s) for profile and real-time (or instant) information for route generation, and continues to mine networks for information related to the trip to ensure the best route is recommended to the user. In one embodiment, profile and real-time information relevant to the trip is used in generating and modifying the route. In addition to generation, monitoring and updating route(s) for the user, the CRGS also can present advertisements of interest to the user for business and services along user's route.

### CROSS REFERENCE To RELATED APPLICATIONS

This application is related to U.S. patent application Ser. No. 12/352,753, filed on Jan. 13, 2009, entitled “Optimization of Map Views Based on Real-Time Data.”

### BACKGROUND OF THE INVENTION

Global positioning system (GPS) navigation is widely used to assist users in reaching a desired destination. A navigation system that utilizes GPS can simply be called a GPS, or a GPS navigation system. Modern GPS navigation systems utilize the mapping information of roads and freeways and the locating capability of GPS to generate travel (or trip) routes for users, and also to monitor the movement of users. Users utilizing GPS navigation systems can be in vehicles, such as airplanes, boats, ships, cars, and bikes, etc., or on foot. Users often type in the addresses or names of the destinations to allow the GPS navigation system to identify routes that are shortest, or quickest to users. Once users start moving, the system track users' movement and update the route information. Recently, navigation applications that serve functions similar to GPS navigation systems have become available to mobile devices, such as mobile cell phones and wireless personal digital assistants (PDAs), etc.

The current GPS navigation systems or mobile devices with navigation function are designed to be used by the general population and are not designed to meet needs of specific individuals. It is in this context that embodiments of the present invention arise.

### SUMMARY OF THE INVENTION

Embodiments of the present invention describe systems and methods for automatically generating route(s) based on users' trip intent and conditions. A user enters his/her trip intent and conditions. A context-sensitive route generation system generates one or more routes based on information surrounding the user's trip intent, such as destination, time, means of transportation, purpose and identity(ies) of traveler(s), and conditions, such as user's limitations, needs, and preferences, for the user. Once the user chooses a route to follow, context-sensitive route generation system (CRGS) keeps track of user's movement and can modify the user's route when a need arises. The CRGS searches one or more networks and the system database(s) for profile and real-time (or instant) information for route generation, and continues to mine networks for information related to the trip to ensure the best route is recommended to the user. In one embodiment, profile and real-time information relevant to the trip is used in generating and modifying the route. In addition to generation, monitoring and updating route(s) for the user, the CRGS also can present advertisements of interest to the user for business and services along user's route.

It should be appreciated that the present invention can be implemented in numerous ways, including as a method, a system, or a device. Several inventive embodiments of the present invention are described below.

In one embodiment, an electronic device implemented method for generating a route for a trip is provided. The electronic device implemented method includes receiving a request for the trip from a user. The trip defines an origination location and a destination location. The electronic device implemented method also includes receiving conditions of the trip from the user, and searching a network and system database for profile and real-time data to identify status information related to the user, the request for the trip, and the conditions of the trip. The electronic device implemented method further includes generating a route for the trip, the route being adjusted based upon the identified status information of the user, and presenting the route to the user on a display.

In another embodiment, an electronic device implemented method for generating a route for a trip is provided. The electronic device implemented method includes receiving a request for the trip from a user, the trip defining an origination location and a destination location, and receiving conditions of the trip from the user. The electronic device implemented method also includes searching a network and system database for profile and real-time data to identify status information related to the user, the request for the trip, and the conditions of the trip. The electronic device implemented method further includes generating a route for the trip, the route being adjusted based upon the identified status information of the user, and presenting the route to the user on a display. In addition, the electronic device implemented method includes receiving real-time status information related to the user, the request for the trip, and the conditions of the trip. The electronic device implemented method also includes determining if the route needs to be modified based on the real-time status information related to the user, the request for the trip, and the conditions of the trip that is received. The electronic device implemented method further includes modifying the route based a change of the real-time status information, otherwise maintaining the route.

In yet another embodiment, a route generation system for automatically generating a route for a trip based on user's trip intent, conditions of the trip, and status information is provided. The route generation system includes a trip intent and conditions server. The travel intent and conditions server stores the trip intent and the conditions of the trip entered by a user. The trip intent and conditions server identify entities related to the user, the trip intent, and the conditions. The route generation system also includes a database for storing information related to roads and routes. The route generation system further includes a search engine for searching and retrieving data from a network and the database for the status information related to entities identified by the trip intent and conditions server. In addition, the route generation system includes a route generator configured to generate a route based on the user's trip intent, conditions of the trip, and status information retrieved by the search engine. The route best suits the user's trip intent and conditions of the trip with the status information taken into consideration. Additionally, the route generation system includes a display generator configured to display the route generated by the route generator.

### BRIEF DESCRIPTION OF THE DRAWINGS

The present invention will be readily understood by the following detailed description in conjunction with the accompanying drawings, and like reference numerals designate like structural elements.

FIG. 1A shows a schematic map of an area of a city with a number of streets intersecting one another, in accordance with one embodiment of the present invention.

FIG. 1B illustrates a relationship between RWEs and IOs on a W4 COMN (Who, What, When, and Where Communication Network), in accordance with one embodiment of the present invention.

FIG. 1C shows a model of the W4 COMN, in accordance with one embodiment of the present invention.

FIG. 2A shows a diagram of a CRGS that takes a user's inputs, information related to road conditions to generate route(s) for the user, in accordance with one embodiment of the present invention.

FIG. 2B shows a diagram of a CRGS that takes a user's inputs, information related to road conditions to generate route(s) for the user, in accordance with another embodiment of the present invention.

FIG. 2C shows a schematic diagram of a CRGS interacting with the user and other components, in accordance with one embodiment of the present invention.

FIG. 2D shows a schematic diagram of a CRGS interacting with other components, in accordance with another embodiment of the present invention.

FIG. 3 shows a process flow of using a CRGS to generate a route(s), in accordance with one embodiment of the present invention.

FIG. 4 shows an entry page for a user to enter the user's travel intent, personal conditions and preferences, in accordance with one embodiment of the present invention.

FIG. 5A shows a display of a navigation system, in accordance with one embodiment of the present invention.

FIG. 5B shows a process flow for a CRGS to display advertisement(s) to a user utilizing a navigation system, in accordance with one embodiment of the present invention.

FIG. 6A shows components of a CRGS, in accordance with one embodiment of the present invention.

FIG. 6B shows two high-lighted areas, in a city, in accordance with one embodiment of the present invention.

FIG. 6C shows two enlarged areas of a city that are enlarged, in accordance with one embodiment of the present invention.

### DETAILED DESCRIPTION

As described above, modern GPS navigation systems utilize the mapping information of roads and freeways and the locating capability of GPS to generate travel routes for users. In addition, modern GPS navigation systems also monitor the movement of users. Users often type in the addresses or names of the destinations, such as names of restaurants, to allow the GPS navigation system to identify routes that are shortest or quickest to users. Typically, navigation systems only present a list of routes when traveling distances are relatively long and there are multiple highways and/or freeways between the starting points and destinations. After a user, such as a driver, selects a route and starts to drive, the navigation system displays the movement of the car on the map of the navigation system in real time. Navigation systems can also be used by users walking around cities or taking hikes. For example, if a user wants to visit a neighborhood in the city that the user is not familiar with, the user can carry a hand-held navigation system; such can be a mobile cell phone, a PDA or a traditional GPS navigation system.

Current navigation systems target the general public and do not allow individual users to customize route generation based on their individual conditions, such as individual limitations, capabilities and preferences, etc. For example, a handicapped wheel chair person, User-A, may live in the city of San Francisco, a city with lots of hills. For instance, User-A may have recently moved to the Nobhill neighborhood of San Francisco, and may need to grocery shop. Being new to the Nobhill neighborhood, User-A would like to use a navigation system (or a GPS device) to find a route to a nearby grocery store. Current navigation systems do not allow a person with special needs, such as the handicapped User-A, to enter User-A's physical condition(s) so that the navigation system can identify a route that takes User-A's physical condition (or limitation) into account.

Being on a wheel chair, User-A might desire that the navigation system identifies a grocery store that is close to User-A's residence or near public transportation. If there are one or more grocery stores in User-A's neighborhood, User-A might like the navigation system to identify a route that is more easily accessible by a person on a wheel chair. For example, the sidewalks along the route are friendly to a wheel chair and the slopes of the streets on the route are not too steep, etc. Existing navigation systems on the market do not provide such capabilities (or functions).

Another example is a user who wants the navigation system to find a route that is tailored to the special condition of the user, User-B. In this example, User-B might wear 4-inch high heels and may want to walk around the city of San Francisco. User-B, who is from out of town, might be staying at a hotel near Union Square in San Francisco, and might be interested in finding a nightclub near User-B's hotel. Because User-B wears 4-inch high heels, User-B would prefer to walk to the nightclub on a route that is relatively flat. Additionally, because User-B has 4-inch high heels, User-B would prefer the nightclub to be nearby. Although User-B can take a cab, User-B prefers to do sight-seeing or window shopping while walking. Further, User-B would like to arrive at the nightclub at about 10 pm (a specific time). Before reaching the nightclub, User-B would also like to visit a cafe or a casual restaurant along the way. User-B prefers Asian food, preferably sushi. User-B wants to leave her hotel at about 6 pm (a specific time). In addition, User-B wants to go to the nightclub and have dinner with a friend (Companion-A). Companion-A might also have special needs and preferences. Since both User-B and Companion-A are female, they would prefer a route that is well lit and relatively safe to walk.

Current navigation systems might be able to find a number of nightclubs near User-B's hotel for User-B. However, current navigation systems would not be able to take inputs from User-B to know that User-B is physically limited (e.g. wearing 4-inch high heels). Current navigation systems also would not be able to take User-B's other inputs of finding a restaurant that serves Asian food (preferably sushi) on the way to the nightclub, while walking with Companion-A, who has her own special needs, preferences, and/or conditions.

In addition to responding to users with special needs, navigation systems that take input for preferences and conditions to generate routes that would be desirable. Although the above examples are related to users either on a wheel chair or walking, the embodiments of the invention apply to any type of user using a navigation system. For example, the user may plan a trip from San Francisco to Disneyland in southern California. The user may have children in the car, and the user would like the navigation system to generate a route that has child-friendly eating/resting places. The user might also want to stop at sightseeing places on the way to Disneyland, etc.

Users enter their special needs, requirements, and/or preferences to allow the system to generate routes that satisfy their special needs, requirements, and/or preferences. Users' special needs, requirements, and/or preferences can be called “User conditions” as part of the route entity. If the user conditions create conflicts, prioritization can be provided to allow the system to generate routes that meet the needs, requirements, and/or preferences according to the defined priorities.

Users who have individual needs, and/or preferences would be interested in a context-sensitive route generator system (CRGS), which automatically generates the best (or most suitable, or optimal) routes for them according to their travel intent, current conditions, needs, and/or preferences.

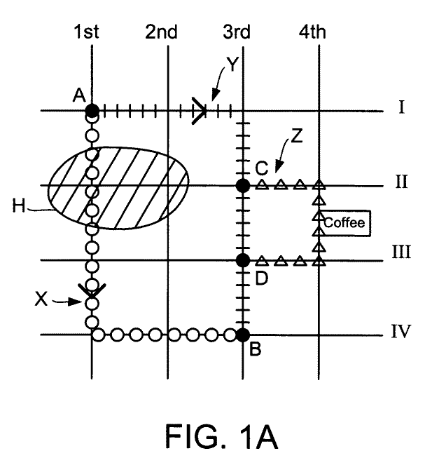

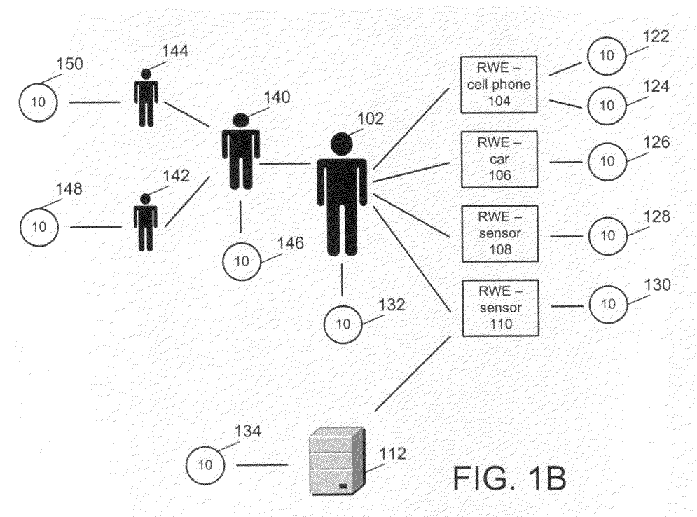

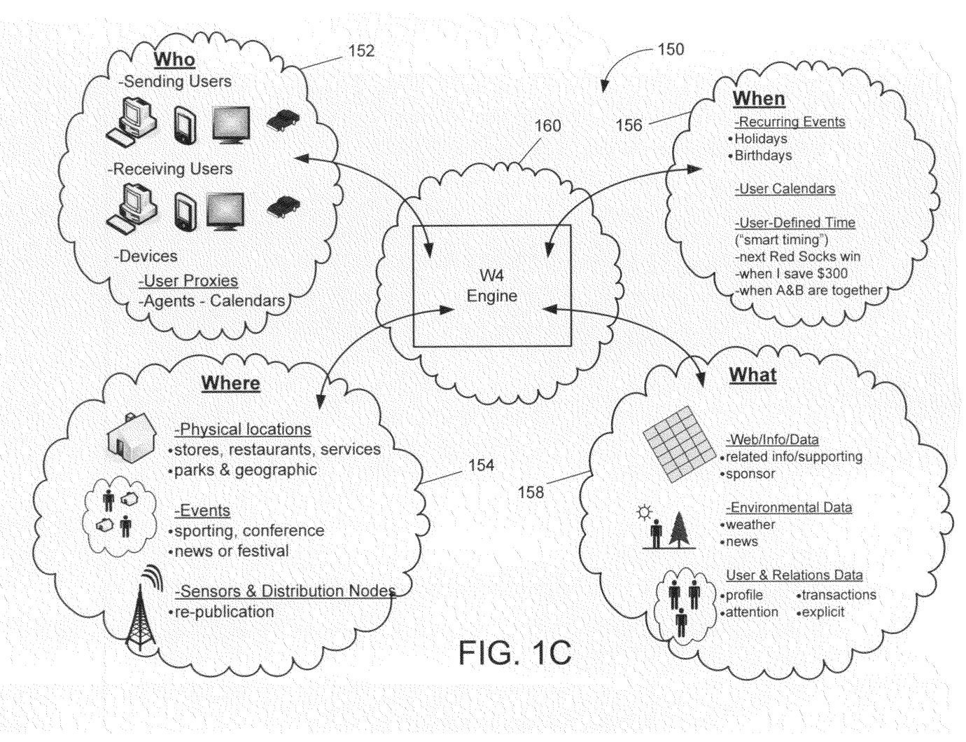

FIG. 1 shows a schematic map of an area of a city with a number of streets intersecting one another, in accordance with one embodiment of the present invention. User-I wants to go from location A to location B. There are several possible routes to allow User-I to go from location A to location B. FIG. 1 shows two exemplary routes, Route X and Route Y. Route X goes along 1^{st} Street and turns to IV Street to reach location B. 1^{st} Street passes a hill H, which is between I Street and III Street, as shown in FIG. 1. The area covered by hill H is represented by an area encircled by H. In contrast, Route Y goes along I Street and turns to 3^{rd} Street to reach location B. User-I is elderly and has a weak knee. User-I has specified that he/she would like the CRGS to find a route that is not hilly. As a consequence, the CRGS presents Route Y to User-I. User-I walks from location A to location B without any problem or complaint. The CRGS processes the trip intent (go from location A to location B), and the conditions, and presents a route from location A to location B, while avoiding the hilly 1^{st} Street.

In addition, User-I can specify to the CRGS that he would like to stop by a coffee shop on the way to location B. In this case, the CRGS finds a coffee shop on 4^{th} Street and between II Street and III Street. The CRGS identifies a Route Z, which uses a portion of Route Y. Route Z, instead of continuing along 3^{rd} Street, turns at location C towards the coffee shop on 4^{th} Street, as shown in FIG. 1 and comes back to 3^{rd} Street after passing the coffee shop. A CRGS that processes the limitation (weak knee) and need (coffee) of User-I can help User-I reach the location B without problem and also map spot, the coffee shop, as desired by User-I. Without the help of such a system, User-I might walk along the hilly 1^{st} Street, presenting User-I with a bad experience.

For the context-sensitive route generation system (CRGS) to generate a route that suits the user's needs and conditions, the CRGS needs to utilize historical data and real-time data related to the road conditions, including weather, traffic, etc., along possible routes and also data related to the user, such as user's past travel history, shopping habit, friends, etc. In one embodiment, the CRGS retrieve such information from databases that store such information, and/or web sites connected to the Internet.

In an embodiment, there is a “W4 Communications Network” or W4 COMN, that uses information related to the “Who, What, When and Where” of interactions with a network to provide improved services to the network's users. A network mentioned here may include a communications network, such as a local area network (LAN), a wide area network (WAN), or a combination of networks, such as the Internet. For example, the network may overlap with the World Wide Web. The communication network enables communications between users and other entities of the network.

The W4 COMN is a collection of users, devices and processes that foster both synchronous and asynchronous communications between users and their proxies. It includes an instrumented network of sensors providing data recognition and collection in real-world environments about any subject, location, user or combination thereof.

The W4 COMN uses a data modeling strategy for creating profiles for not only users and locations but also any device on the network and any kind of user-defined data with user-specified conditions from a rich set of possibilities. Using Social, Spatial, Temporal and Logical data available about a specific user, topic or logical data object, every entity known to the W4 COMN can be mapped and represented against all other known entities and data objects in order to create both a micro graph for every entity as well as a global graph that interrelates all known entities against each other and their attributed relations.

In order to describe the operation of the W4 COMN, two elements upon which the W4 COMN is built are first introduced, real-world entities (RWEs) and information objects (IOs). These distinctions are made in order to enable correlations to be made from which relationships between electronic/logical objects and real objects can be determined. A real-world entity (RWE) refers to a person, device, location, or other physical thing known to the W4 COMN. Each RWE known to the W4 COMN may be assigned or otherwise provided with a unique W4 identification number that absolutely identifies the RWE within the W4 COMN.

RWEs can interact with the network directly or through proxies, which can themselves be RWEs. Examples of RWEs that interact directly with the W4 COMN include any device such as a sensor, motor, or other piece of hardware that connects to the W4 COMN in order to receive or transmit data or control signals. Because the W4 COMN can be adapted to use any and all types of data communication, the devices that can be RWEs include all devices that can serve as network nodes or generate, request and/or consume data in a networked environment or that can be controlled via the network. Such devices include any kind of “dumb” device purpose-designed to interact with a network (e.g., cell phones, cable television set top boxes, fax machines, telephones, and radio frequency identification (RFID) tags, sensors, etc.).

The W4 COMN allows associations between RWEs to be determined and tracked. For example, a given user (an RWE) can be associated with any number and type of other RWEs including other people, cell phones, smart credit cards, personal data assistants, email and other communication service accounts, networked computers, smart appliances, set top boxes and receivers for cable television and other media services, and any other networked device. This association can be made explicitly by the user, such as when the RWE is installed into the W4 COMN. This explicit association can include the user identifying a specific relationship between the user and the RWE. RWEs can also be implicitly associated with a user based on a current situation. For example, a weather sensor on the W4 COMN can be implicitly associated with a user based on information indicating that the user lives or is passing near the sensor's location.

An information object (IO), on the other hand, is a logical object that stores, maintains, generates, serves as a source for or otherwise provides data for use by RWEs and/or the W4 COMN. IOs are distinct from RWEs in that IOs represent data, whereas RWEs can create or consume data (often by creating or consuming IOs) during their interaction with the W4 COMN. Examples of IOs include passive objects such as communication signals (e.g., digital and analog telephone signals, streaming media and interprocess communications), email messages, transaction records, virtual cards, event records (e.g., a data file identifying a time, possibly in combination with one or more RWEs such as users and locations, that can further be associated with a known topic/activity/significance such as a concert, rally, meeting, sporting event, etc.), recordings of phone calls, calendar entries, web pages, database entries, electronic media objects (e.g., media files containing songs, videos, pictures, images, audio messages, phone calls, etc.), electronic files and associated metadata.

FIG. 1B illustrates an example of the relationships between RWEs and IOs on the W4 COMN. In the embodiment illustrated in FIG. 1B, a user 102 is a RWE of the network provided with a unique network ID. User 102 is a human that communicates with the network via proxy devices 104, 106, 108, 110 associated with the user 102, all of which are RWEs of the network and provided with their own unique network ID. Some of these proxies can communicate directly with the W4 COMN or can communicate with the W4 COMN via IOs such as applications executed on or by the device.

User 102 can also be directly associated with other people, such as the person 140 shown, and then indirectly associated with other people 142, 144 through their associations as shown. Again, such associations can be explicit (e.g., the user 102 can have identified the associated person 140 as his/her father, or can have identified the person 140 as a member of the user's social network) or implicit (e.g., they share the same address).

Tracking the associations between people (and other RWEs as well) allows the creation of the concept of “intimacy.” Intimacy is a measure of the degree of association between two people or RWEs. For example, each degree of removal between RWEs can be considered a lower level of intimacy, and assigned lower intimacy score. Intimacy can be based solely on explicit social data or can be expanded to include all W4 data including spatial data and temporal data.

Each RWE 102, 104, 106, 108, 110, 112, 140, 142, 144 of the W4 COMN can be associated with one or more IOs as shown. Continuing the examples discussed above, FIG. 1B illustrates two IOs 122, 124 as associated with the cell phone device 104. One IO 122 can be a passive data object such as an event record that is used by scheduling/calendaring software on the cell phone, a contact IO used by an address book application, a historical record of a transaction made using device 104 or a copy of a message sent from device 104. IOs 122, 124 can be locally stored on device 104 or stored remotely on some node or datastore accessible to the W4 COMN, such as a message server or cell phone service datacenter. Furthermore, those RWEs which can only interact with the W4 COMN through proxies, such as people 102, 140, 142, 144, in accordance with one embodiment of the present invention.

In order to correlate RWEs and IOs to identify relationships, in one embodiment, the W4 COMN makes extensive use of existing metadata and generates additional metadata where necessary. Metadata is loosely defined as data that describes data. For example, given an IO such as a music file, the core, primary or object data of the music file is the actual music data that is converted by a media player into audio that is heard by the listener. Metadata for the same music file can include data identifying the artist, song, etc., album art, and the format of the music data. This metadata can be stored as part of the music file or in one or more different IOs that are associated with the music file or both.

FIG. 1C illustrates an embodiment of a model of the W4 COMN 150. As shown in FIG. 1C, W4 COMN 150 includes a Who Cloud 152, a Where cloud 154, a When cloud 156, a What cloud 158, and a W4 engine 160. W4 COMN 150 creates an instrumented messaging infrastructure in the form of a global logical network cloud conceptually sub-divided into networked-clouds for each of the 4Ws: Who (Who cloud 152), Where (Where cloud 154), What (What cloud 158), and When (When cloud 156). Who cloud 502 includes all users, whether acting as senders, receivers, data points or confirmation/certification sources as well as user proxies in the forms of user-program processes, devices, agents, calendars, etc. For example, Where cloud 154 may include all physical locations, events, sensors or other RWEs associated with a spatial reference point or location. When cloud 156 may include natural temporal events (that is events that are not associated with particular location or person such as days, times, seasons) as well as collective user temporal events (holidays, anniversaries, elections, etc.) and user-defined temporal events (birthdays, smart-timing programs). What cloud 158 may include known data—web or private, commercial or user—accessible to the W4 COMN, including for example environmental data like weather and news, RWE-generated data, IOs and IO data, user data, models, processes and applications. Thus, conceptually, most data is contained in the What cloud 158.

As this is just a conceptual model, it should be noted that some entities, sensors or data will naturally exist in multiple clouds either disparate in time or simultaneously. Additionally, some IOs and RWEs can be composites in that they combine elements from one or more clouds. Such composites can be classified or not as appropriate to facilitate the determination of associations between RWEs and IOs. For example, an event consisting of a location and time could be equally classified within When cloud 156, What cloud 158 and/or Where cloud 154.

W4 engine 160 is center of the W4 COMN's central intelligence for making all decisions in the W4 COMN. An “engine” as referred to herein is meant to describe a software, hardware or firmware (or combinations thereof) system, process or functionality that performs or facilitates the processes, features and/or functions described herein (with or without human interaction or augmentation). W4 engine 160 controls all interactions between each layer of the W4 COMN and is responsible for executing any approved user or application objective enabled by W4 COMN operations or interoperating applications. In an embodiment, the W4 COMN is an open platform upon which anyone can write an application. To support this, it includes standard published APIs for requesting (among other things) synchronization, disambiguation, user or topic addressing, access rights, prioritization or other value-based ranking, smart scheduling, automation and topical, social, spatial or temporal alerts.

One function of W4 engine 160 is to collect data concerning all communications and interactions conducted via W4 COMN 150, which can include storing copies of IOs and information identifying all RWEs and other information related to the IOs (e.g., who, what, when, where information). W4 engine 160 is also responsible for identifying RWEs and relationships between RWEs and IOs from the data and communication streams passing through the W4 COMN. The function of identifying RWEs associated with or implicated by IOs and actions performed by other RWEs is referred to as entity extraction. Entity extraction includes both simple actions, such as identifying the sender and receivers of a particular 10, and more complicated analyses of the data collected by and/or available to the W4 COMN, for example determining that a message listed the time and location of an upcoming event and associating that event with the sender and receiver(s) of the message based on the context of the message or determining that an RWE is stuck in a traffic jam based on a correlation of the RWE's location with the status of a co-located traffic monitor.

In an embodiment, W4 engine 160 represents a group of applications executing on one or more computing devices that are nodes of the W4 COMN. For the purposes of this disclosure, a computing device is a device that includes a processor and memory for storing data and executing software (e.g., applications) that perform the functions described. Computing devices can be provided with operating systems that allow the execution of software applications in order to manipulate data.

Some RWEs can also be computing devices such as smart phones, web-enabled appliances, PCs, laptop computers, and personal data assistants (PDAs). Computing devices can be connected to one or more communications networks such as the Internet, a publicly switched telephone network, a cellular telephone network, a satellite communication network, a wired communication network such as a cable television or private area network. Computing devices can be connected any such network via a wired data connection or wireless connection such as a wi-fi, a WiMAX (802.36), a Bluetooth or a cellular telephone connection.

Local data structures, including discrete IOs, can be stored on a mass storage device (not shown) that is connected to, or part of, any of the computing devices described herein including W4 engine 160. For example, in an embodiment, the data backbone of the W4 COMN, discussed below, includes multiple mass storage devices that maintain the IOs, metadata and data necessary to determine relationships between RWEs and IOs as described herein. A mass storage device includes some form of computer-readable media and provides non-volatile storage of data and software for retrieval and later use by one or more computing devices.

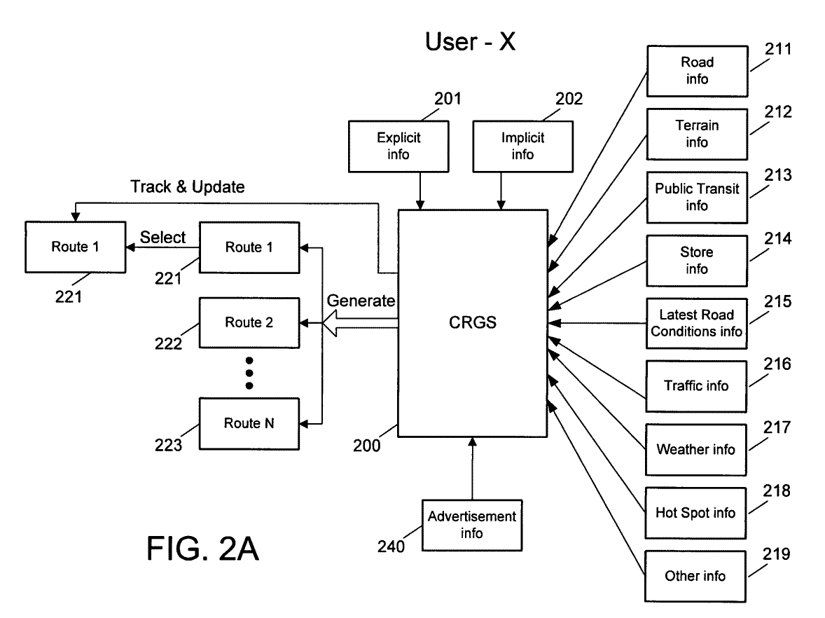

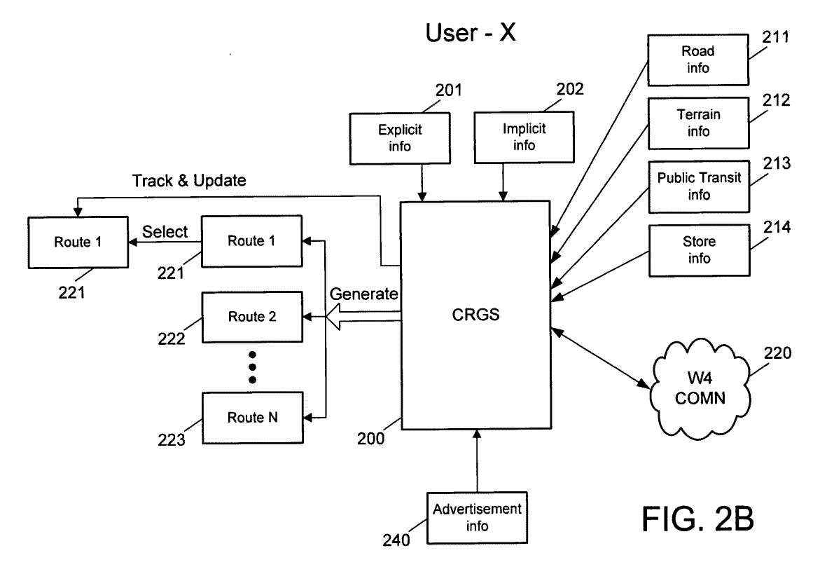

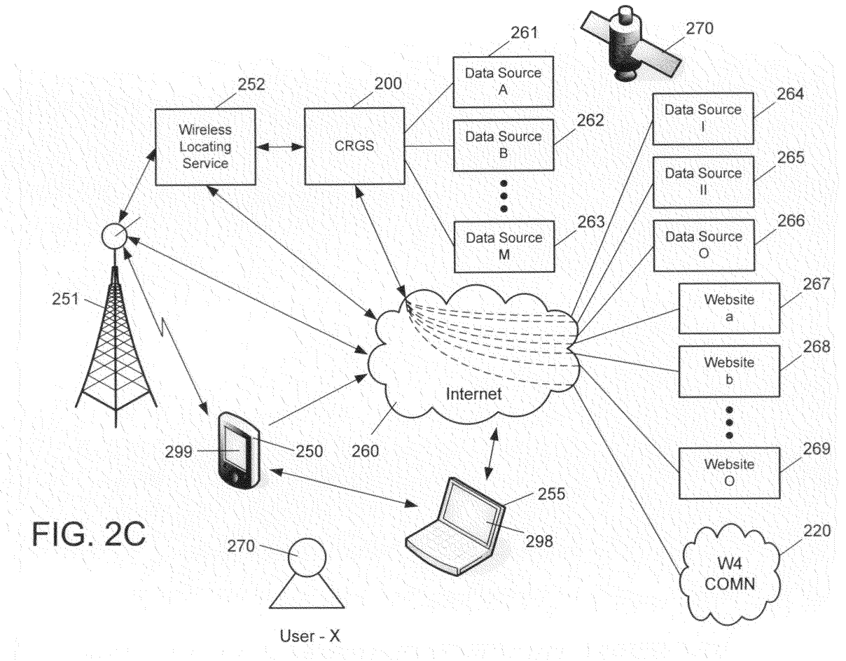

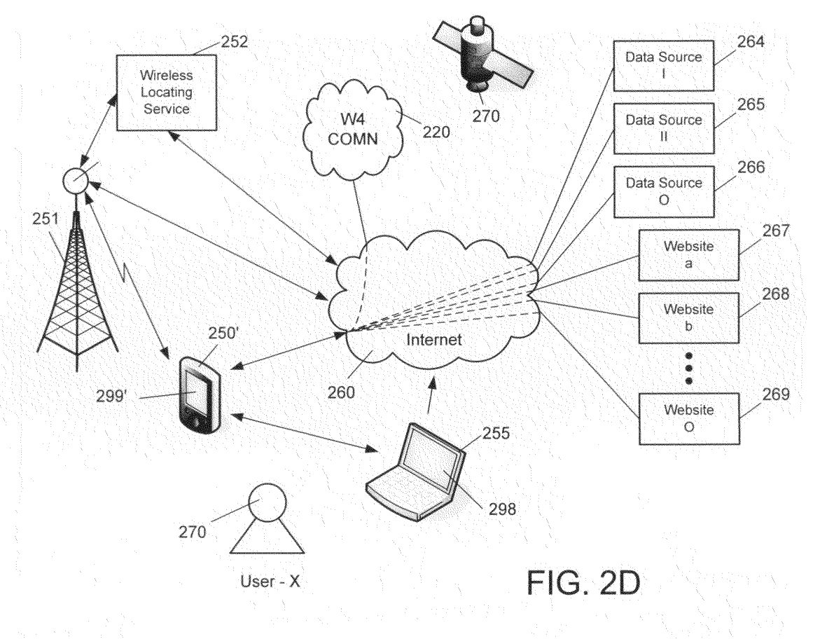

FIG. 2A shows a diagram of a CRGS (Context-sensitive Route Generation System) 200 that takes a user's inputs and information related to the road conditions to generate route(s) for the user, in accordance with one embodiment of the present invention. The CRGS 200 takes in information related to the User-X. Information of User-X can include explicit information 201 and implicit information 202. Explicit information is provided directly by User-X. Explicit information 201 includes User-X's travel intent, User-X's special need(s), and/or preferences for a particular route (or trip) that need to be considered by the CRGS 200. User-X's travel (or trip) intent can be ascertained using data related to “where”, “when”, “who”, “how”, and “what” of the trip entered by User-X. For example, explicit travel intent may include destination of the trip (where), time of travel (when), means of transportation (how), purpose of the trip (what), and identities of user and user's traveling companion (who) for a particular trip. Other example of “where” data may include the starting point of the trip, and points of interests to visit during trip. The “how” data for the trip may include by car, on foot, by public transportation, or by a combination of the above mentioned means. For example, if User-X wants to travel by public transportation, the route would be different from the route by car. In addition, the locations and schedules of public transportation would need to be taken into consideration. The “when” data of the trip may include when the trip would occur, and available time period for traveling (such as one day or two days). The traveling time of the trip can affect the route generation and selection. For example, a driving trip on the weekend or during the week might yield different route(s), due to different traffic patterns at different time periods.

The “what” (or purpose) data of the trip can also affect the route generation. For example, User-X's purpose of the trip can be sight-seeing, buying grocery, or having a dinner. If User-X's purpose of the trip is to buy grocery, User-X might need help in finding a grocery store. User-X would need to reveal the purpose of the trip being “buying grocery” or “reaching a grocery store” to the system in order for the system to generate a list of grocery stores for User-X to select. In addition, “who” User-X or User-X's companion are could affect the route generation. For example, the CRGS need to know the identifies of User-X and User-X's companion to know their profiles and past travel histories/patterns, which would be considered during route generation. For each trip, not all information related to “who”, “where”, “how”, “what”, and “when” of the trip need to be entered. For example User-X can specify one W, such as where the destination is, or User-X can specify both the travel time (when) and the purpose of the trip (what).

As mentioned above, explicit information can also include User-X's individual condition(s) and/or need(s), which can include User-X's accessibility, mobility and social profile. User-X's accessibility refers to the physical limitation(s), such as User-X being physically impaired (e.g. on a wheel chair), and metal limitation(s). The physical limitation of the user might not be permanent. Mobility of User-X reflects how fast or slow User-X typically walks. User-X's social profile can include information such as who is traveling with User-X (travel companion(s)), friends of User-X, and enemies of User-X (or people User-X would like to avoid), etc. For example, if User-X is walking around the city and one of User-X's friends happens to live in the neighborhood and the friend's address is in the CRGS, User-X would be happy if the CRGS plans a route to stop by the friend's house during the trip or alert User-X that a friend lives in the neighborhood. User-X can enter his/her special needs and/or preferences into the CRGS. For example, User-X likes specialty coffee drinks very much, especially coffee drinks from Starbucks™. By specifying interests and preferences, the CRGS can take these factors into consideration while planning the trip (or route). The CRGS might need to weigh different factors entered by User-X or related to User-X to generate the route(s) based on priorities listed by User-X.

As mentioned above, User-X's individual profile, which includes conditions, needs and preferences or User-X, can be explicitly entered by User-X. However, if the information is entered before, the system is able to link User-X to the information of User-X and does not need User-X to re-enter this information for each trip. In one embodiment, information related to User-X's profile only needs to be explicitly entered by User-X once. After the first entry, such information becomes implicit information for User-X. In one embodiment, implicit information of User-X can be obtained by accessing the W4 COMN described above. As mentioned above, W4 COMN collects and process data related to various real-world entities (RWEs) to identify their relationships and context. To obtain information about User-X, CRGS can access the W4 engine 160 of the W4 COMN 150 of FIG. 1C. W4 engine can perform entity extraction of User-X to find information relevant to User-X. Further, W4 engine can extract information of User-X that is related to traveling/trips and routes.

If User-X has used the CRGS system before, the CRGS system could have stored User-X's profiles, which could include User-X physical conditions, stores and places that User-X frequently visits, and User-X's past traveling histories, etc. The information stored in the CRGS based on User-X's past entries or travel logs becomes implicit information of User-X, and can be used by the CRGS in generating routes recommendations for User-X. In FIG. 2A, the implicit information 202 of User-X is information entered by User-X in the past, in accordance with one embodiment of the present invention. Alternatively, the CRGS might have collected many profiles of users and can correlate User-X to other users of CRGS who share similar backgrounds with User-X and generates an implicit profile of User-X, in accordance with one embodiment of the present invention. For example, User-X enters User-X's age, gender, geographical location, and other information related to User-X. Based on information entered by User-X, the CRGS can correlate User-X with other users with similar backgrounds to identify likes, dislikes, and travel patterns of people with such backgrounds. Of course, if there is a conflict between what User-X enters and what the CRGS generates, the information entered by User-X should be used, instead of information generated by correlation.

In addition, if User-X is traveling with a companion, User-X can also indicate that he/she is traveling with a companion to the CRGS, in accordance with one embodiment of the present invention. As mentioned above for the travel intent, whom the User-X is traveling with can also be described under travel intent (WHO). In one embodiment, the CRGS can be configured to allow User-X to enter limitation(s), need(s), and/or preferences of User-X's travel companion. Alternatively, User-X travels with more than one companion and the CRGS is configured to take in profiles of more than one companion. In addition, User-X's travel companion(s) could already have his/her profile in the CRGS system. In this case, once the identity of the companion is entered, the CRGS could identify the companion's profile from the system. Alternatively, the user profiles of User-X and User-X's travel companion(s) can be obtained by accessing W4 COMN, as described and mentioned above.

In addition to explicit and implicit information of User-X, the CRGS system needs information regarding the road 211. The road information (for route generation) 211 can include, but not limited to, intersection, streets, stop signs, sidewalks, topology of streets, freeways, freeway ramps, and sidewalk ramps for wheel chairs, etc. Road information that is not currently available, such as sidewalk ramps for wheel chairs, can be made available if there is a demand for the information. With the advancement of information exchange, a lot of information, previously kept private, is open and made available to the public through the Internet.

In one embodiment, the CRGS system takes in terrain information 212. Terrain (or topographical) information shows the hills and slopes, etc., of roads and is useful for pedestrians, people in wheel chairs, bikers, etc. Public transit information 213 can also be included, in accordance with one embodiment of the present invention. Users of the CRGS systems might want to use public transit. The public transit information may include schedules and stop locations for the public transit, such as bus stops and subway stations.

In one embodiment, store information 214 can be included in the CRGS. The store information can include locations and types of services of the stores. For example, the stores can include gas stations, restaurants, coffee shops, clothing stores, etc. The information can be made available and be integrated directly to the system. Alternatively, the CRGS can crawl the Internet for store information and integrate the store information available on the Internet to the CRGS. Stores change on a regular bases. New stores are open and existing stores are closed regularly. Often the opening and comments of new stores are available and updated on the Internet more frequently than databases managed by information services. Indexing information available on the Internet keeps information in the CRGS current and updated.

The CRGS can also integrate latest road condition information 215 into its database(s), in accordance with one embodiment of the present invention. Examples of the latest road condition information 215 include the scheduled close-off of freeways and roads. Sometimes, freeways are closed due to construction or repair, and roads are closed for parades or repair. Such information may be available in government web sites and CRGS can crawl (or index) the government web sites to get such information. In one embodiment, traffic information 216 can also be integrated into the CRGS. Traffic updates, such as accidents in certain freeways, can be integrated the system. CRGS can utilize such information to redirect users to avoid traffic congestion.

In one embodiment, weather information 217 is integrated into the CRGS, since weather condition can greatly affect the travel speed of cars and pedestrians. In another embodiment, hot spots (popular spots) information 218 is integrated into the CRGS. There are services and/or companies that utilize information from billion points of GPS and WiFi positioning data collected in the past few years and in real time to construct the popular spots, where many people gather, on maps. For example, http://www.citysense.com provides top live hotspots for users to know where are the popular locations in a city at a given time. “citysense.com” also provide information on how busy the city is compared to normal (average). If the city is currently busy, users of CRGS might need to leave earlier to have sufficient time to reach destinations. There could be other types of information be fed into CRGS 200. Other types of information 219 is also shown in FIG. 2A.

The information mentioned above that can be integrated with the CRGS, such as information 211 to 218, are merely examples. The CRGS can integrate with only a portion of the information described above, or integrate with more information that has been described above. The CRGS can be integrated with any information that would affect the traveling of the users of CRGS. How much information is integrated in the CRGS depends on the storage capacities and processing capabilities of CRGS 200, and also on the availability of the information. If the CRGS 200 has many storages and powerful processor(s), more information can be integrated. The information stored in the CRGS can be directly fed to the CRGS. Alternatively, such information can be loaded into CRGS through Internet (not shown). As mentioned above, CRGS 200 can also continue indexing web sites that have relevant and updated information that could affect the route selection.

With the information, explicit 201 and implicit 202, entered by User-X, the CRGS processes the information related to the route query, such as road condition info 211 to hot spot info 218, to generate one or more routes, such as route-1 221, route-2 222, and route-N 223, that meet the travel intent, and User-X's limitations and needs. User-X can choose one route, such as route-1 221, to travel. The CRGS 200 can continue tracking with the assistance of GPS and/or wireless positioning service(s) and updating the selected route 221 based on information collected by CRGS. For example, if there is traffic information that indicates a delay in one of the freeway on User-X's route-1 221, CRGS can modify the route and can indicate to User-X that the change is due to traffic condition.

Some of the information integrated into the CRGS is relatively fixed, such as road information 211, and does not change often. However, some information gets updated regularly. The relatively fixed information that is integrated with CRGS needs to be updated only on a regular basis to keep the information current and useful. On the other hand, some information changes constantly and only the most recent information is useful.

FIG. 2B shows a diagram of a CRGS (Context-sensitive Route Generation System) 200′, in accordance with another embodiment of the present invention. In the embodiment of FIG. 2B, the CRGS stores information that is relevant consistent and does not change very frequently, such as road information 211, terrain information 212, public transit information 213, and store information 214. For information that changes very frequently or that only the latest matters, CRGS 200′can access such information through W4 COMN 220, or more precisely the W4 engine of the W4 COMN 220. For example, if the identity of User-X and/or User-X's companion are entered into CRGS 200′, CRGS 200′ can access W4 COMN to obtain information related to User-X and/or User-X's companion. W4 COMN can further narrow the focus of the information search to travel and/or route related. By obtaining such information through W4 COMN, the storage and computation resources required of the CRGS 200′ can be reduced, since the storage and computation resources rest on the W4 COMN. CRGS 200′ can also access W4 COMN for information that changes frequently or for latest information, such as latest road condition information (215 of FIG. 2A), traffic information (216 of FIG. 2A), weather information (217 of FIG. 2A), hot spot information (218 of FIG. 2A), and other information (219 of FIG. 2A).

As mentioned above, W4 COMN collects and process data related to various real-world entities (RWEs) to identify their relationships and context. To obtain information about User-X, CRGS can access the W4 engine 160 of the W4 COMN 150 of FIG. 1C. W4 engine can perform entity extraction of User-X to find information relevant to User-X. Further, W4 engine can extract information of User-X that is related to traveling/trips and routes. For example, if the starting point and the end point of User-X's trip are identified, CRGS 200′ can access W4 COMN for information related to entities related to the trip request, such as these two locations, roads and cities along the possible route(s) between these two locations, User-X, etc. W4 COMN has gathered a network of information, which can be processed to identify the profile (or historical) and real-time information related to these entities. The starting point, and the end point of the trip, the possible routes for the trip, and User-X can all be considered as real-world entities (RWEs) of the W4 COMN. The W4 engine of the W4 COMN can process data related to the entities to extract information (or data) related to the entities to provide it the CRGS 200′. CRGS 200′ then process the information obtained from the storages in CRGS 200′ and from W4 COMN to identify suitable route(s) for User-X.

The CRGS system allows users to enter route intent, limitations and/or conditions to generate routes that are context-sensitive, which may include topographical context, user context, and intent context, etc, to customize the route(s) for users. The Context-sensitive Route Generator System (CRGS) allows users to view and use the best routes for them according to their current physical, mental and social conditions, and also the current road conditions. The system will dynamically recalculate route based on the changes in the conditions. The system generates the routes, which could include maps, based on information related to road conditions available and/or information related to destinations entered by the users, and conditions/limitations entered by the users.

In addition to generating, monitoring and updating routes for users, the CRGS can highlight and/or alert users of stores that are of interests to users along the routes, in accordance with one embodiment of the present invention. CRGS can continue pinging W4 COMN for information related to the entities along the travel route for real-time information to check if the route needs to be modified based on real-time information.

The CRGS can be integrated with an advertising system that stores and processes advertisements sponsored by businesses and/or merchants along the routes. Alternatively, the business and/or merchants can place advertisements directly to the CRGS. For example, a local shoe shop can place an advertisement through the CRGS for users who walk through the neighborhood near the shoe shop. Walkers might feel that their shoes are too old or too uncomfortable while they walk and could be interested in purchasing shoes. Such advertising by businesses in the neighborhood along the routes is more targeted and effective. For example, the CRGS can alert a user walking along a route that there is a shoe shop around the corner and display the location of the shoe shop in the navigation system held by the user. The CRGS also can alert the user that the shoe shop currently offers a coupon through the CRGS. FIG. 2A shows that advertisement information 240 being fed to the CRGS to allow CRGS to display and alert users of business nearby.

FIG. 2C shows an embodiment of the CRGS 200″ interacting with the user 270 and other components. In the embodiment in FIG. 2C, a user, such as User-X 270, interacts with the CRGS 200 through a mobile device 250. The mobile device (or wireless device) 250 has a display screen 299. Examples of the mobile device 250 include, but not limited to, cell phones, personal digital assistants (PDAs), and receivers of GPS. In one embodiment, the mobile device 250 is a handheld device. In another embodiment, the wireless device is a device attached to a vehicle. The mobile device 250 has the capability of displaying the route and location of wireless device. The mobile device 250 further has the capability of receiving and processing inputs from a user, such as User-X 270. In one embodiment, the mobile device 250 exchanges wireless signals with a cell tower 251, which exchanges information with the CRGS 200″ directly or through the Internet 260. As mentioned above, the CRGS 200″ has the capability of processing requests for route generation to provide routes based on the requests from users. The route(s) generated by the CRGS 200″ meets the needs, conditions and preferences (or the context) of the trip specified by the user, such as User-X 270. In one embodiment, the cell tower 251 can also exchange information with a system of a wireless locating service 252 to allow the system 252 to identify the location of the mobile device 250.

In one embodiment, the CRGS 200″ is coupled to a number of data (or information) sources, Data Source A 261, Data Source B 262, . . . , and Data Source M 263. Examples of Data Sources are descried above, such as information sources 211, 212, . . . , and 240. In one embodiment, some of the data sources are not directly coupled to the CRGS 200. Instead the CRGS 200″ access the data sources through Internet 260. FIG. 2C shows that CRGS 200″ access Data Source I 264, Data Source II 265, . . . , and Data Source O 266 through Internet. Examples of Data Sources are descried above, such as information sources 211 to 240. Alternatively, the CRGS crawls or index a number of Internet we sites, such as Web Site a 267, Web Site b 268, . . . , and Web Site p 269, through Internet to find updated information relevant to the road conditions.

As mentioned above, some information, such as weather and traffic, is real-time (or only real-time information is relevant) or requires large processing resources, such as user profile, to incorporate historical information. Processing real-time information and/or profile information can be handle by a system(s) or network that has large computing resources, such as W4 COMN. In one embodiment, the CRGS 200″ has access to the W4 COMN 220 to request information from W4 COMN for information relevant to User-X's trip. Examples of information requested from the W4 COMN include, but not limited to, User-X's profile, profiles of User-X's friends and/or foes, weather, traffic, latest road conditions, hot spot information, etc. In one embodiment, the CRGS 200″ accesses the W4 COMN 220 through a W4 engine, which has been described above in FIG. 1C.

Alternatively, the user, such as User-X 270, can also access the CRGS through a computer 255, which allows users to easily enter personal profile, travel intent, and other information relevant to the trip more easily. The computer 255 has a display screen 298. Once the information is entered to the CRGS through computer 255, the user can access the information related to the trip or related to the user through the mobile device 250. In one embodiment, the mobile device 250 could be linked to the computer 255 directly or through Internet to import the information, such as travel intent and conditions, entered by the user. Once the user, such as User-X, selects one of the routes generated by the CRGS and starts to move along the route, the CRGS tracks the user's location either through GPS (with the assistance of a satellite 270), or through the WiFi positioning, or a combination of both. In one embodiment, tracking the WiFi positioning of the mobile device 250 is performed by a system of a wireless locating service 252. While the user moves along his/her traveling route, CRGS 200″ continues to track the user's movement and continues to gather information relevant to the user's traveling route to modify the route generated, if necessary, and to alert the user of changes of travel condition, and/or to alert the user of stores and/or services nearby. In one embodiment, W4 COMN 220 tracks the entities, such as travel start points, travel end points, streets and cities along the travel routes, User-X, and User-X's friends and foes, etc, related the User-X's trip and provides real-time information of these entities to the CRGS 200″. If the real-time information provided by W4 COMN and processed by CRGS 200″ indicates that modification of the trip route might be needed, CRGS 200″ would alert the User-X of such information and would suggest to User-X of change(s) might be needed. For example, User-X is driving along a highway 101 from San Francisco to Monterey. The real-time information collected and processed by W4 COMN 220 indicates that there is an accident on highway 101 at about 20 miles from the current driving location of User-X. The entity tracking capability of W4 COMN 220 would identify such information to provide to CRGS 200″. CRGS 200″ would process such information and prompt User-X to consider taking a local route to get around the section of highway 101 where the accident occurs.

Alternatively, the CRGS can be part of the mobile device 250′, as shown in FIG. 2D, in accordance with one embodiment of the present invention. To enable the CRGS and the wireless navigation device to be merged into one, in one embodiment, the mobile device 250′ has computing capability, memory and access to a search engine to index web sites for information relevant to travel conditions. Similar to the CRGS 200″ of FIG. 2C, the mobile device 250′ that is also a CRGS exchanges wireless signals with a cell tower 251, which also exchanges information with a system of a wireless locating service 252 to allow the system 252 to identify the location of the mobile device 250′. In FIG. 2C, the CRGS 200″ is coupled to a number of data (or information) sources, Data Source A 261, Data Source B 262, . . . , and Data Source M 263. Examples of Data Sources are descried above, such as information sources 211, 212, . . . to 240. However, for mobile device 250′, the information stored in Data Source A 261, Data Source 262, . . . , and Data Source M 263 is integrated in mobile device 250′. Other elements in FIG. 2D function similar to those in FIG. 2C. Similar to the CRGS 200″ described above, the mobile device 250′ with the CRGS can access W4 COMN 220 for real-time and profile information relevant to the trip requested by the user, such as User-X 270.

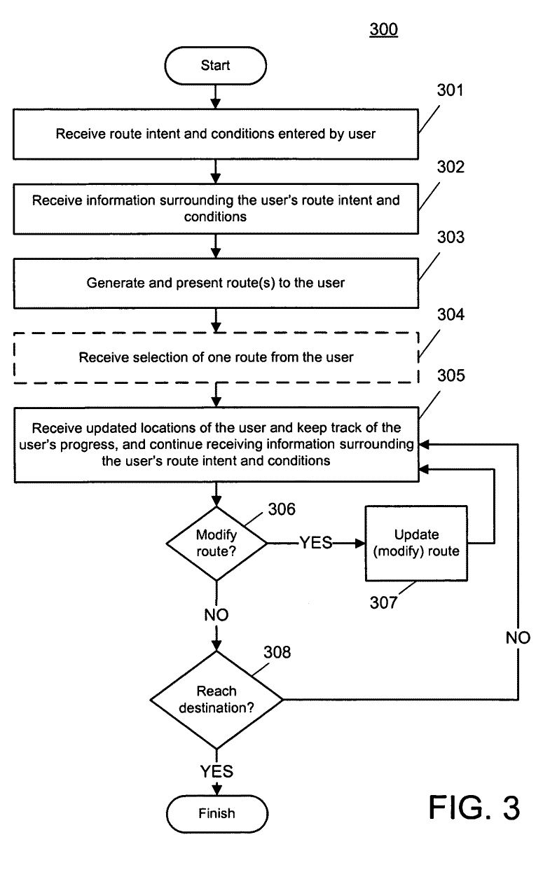

FIG. 3 shows a process flow 300 for using a CRGS to generate a route(s), in accordance with one embodiment of the present invention. At operation 301, the CRGS system receives route intent (or travel intent), user's conditions, which may include user's limitations, needs and preferences, from the user. As mentioned above, the route intent may include one or more of the “who”, “where”, “how”, “when”, and “how” of the trip described above. User's conditions may include the user's physical, metal and/or social conditions. User can also specify preferences for the trip, such as stop by a coffee shop along the way, etc. At operation 302, the system receives information surrounding user's travel intent, conditions, and/or preferences, entered explicitly by the user and/or implicitly existing in the CRGS system. As discussed above, the CRGS mines the Internet and/or identified sites in the Internet for profile (or historical) and real-time information surrounding the user's travel intent, the user's conditions, and/or the user's preferences. For example, if the user indicates Disneyland as the travel destination and travel time is a particular weekend, the CRGS would search for information, such as traffic pattern and weather condition along the way to Disneyland and around the weekend the travel will take place. Some information needed to generate the route(s) may already exist in the CRGS. In one embodiment, the CRGS access the W4 COMN to obtain such information. As mentioned above, W4 COMN searches and indexes Internet, systems and networks for profile and real-time information to establish relationships between RWEs and IOs. W4 COMN is configured to extract information surrounding various entities (or RWEs). CRGS provides entities related to the route request to W4 COMN to access (or ping) for profile and real-time information related to the entities provided to the W4 COMN.

At operation 303, the CRGS generates the route(s) for the user and present the route(s) to the user. The CRGS analyzes the data surrounding the route query to calculate a route or a number of routes that meet the conditions specified by the user. The data surrounding the route query may include spatial conditions, such as road and traffic conditions, and accessibility condition, etc., and temporal conditions, such as time of the day, time during of the trip, weather condition currently or during travel, etc. The route(s) generated best meets the requirements and conditions of the trip. The process of generating a route(s) can finish at operation 303. However, the process flow 300 can continue after operation 303 to become a process flow for a user to use a navigation system, in accordance with one embodiment of the present invention.

After operation 303 there is an optional operation 304. At an optional operation 304, the CRGS receives a selection of route from the user. As mentioned above, the CRGS might present a number of routes to user to choose. However, if the CRGS only generates one route, which is typical for a short trip, then operation 304 can be skipped. After operation 304, at next operation 305, the CRGS receives updated locations (or signals of updated locations) of the user and keeps track of user's progress along the travel route, and continues receiving updated information surrounding user's travel intent, conditions, and preferences. The CRGS continues to mine for information surrounding the trip during the trip. In one embodiment, the CRGS also tracks the user's choices and corrections. The user might decide to deviate from the selected route. The CRGS tracks user's choice and update the route.

As mentioned above in FIGS. 2C-2D, the CRGS and the wireless navigation system used by the user can be integrated into one system, such as system 250′, or be separated into two systems, such as systems 200 and 250 of FIG. 2C.

At operation 306, the CRGS checks if there is a need to update route based the current road condition and/or user location. If there is a road condition change, such as by due to traffic jam at the next stoplight, the CRGS can modify the route to allow the user to avoid traffic. Sometimes, user might decide to deviate from the planned route. For example, the user might see in next block there is a grocery store and decides to take a detour to shop at the grocery store. Under such a circumstance, the CRGS would update (or modify) the route according to the user's current location. Therefore, the process flow proceeds to operation 307 to update (or modify) the route for the user. Otherwise, the process flow proceeds to next operation 308 of checking if the destination has been reached. If the answer the “yes”, the process flow finishes. Otherwise, the process flow returns to operation 305.

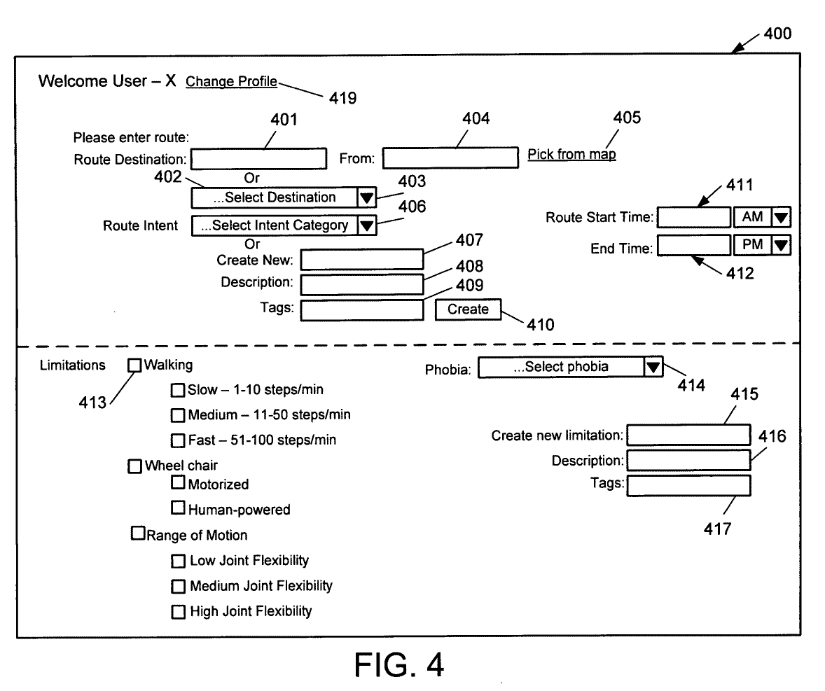

FIG. 4 shows an entry page 400 for a user, such as User-X, to enter his/her travel intent, personal conditions and preferences, in accordance with one embodiment of the present invention. The entry page 400 could be a web entry page or a page generated by an application. Entry page 400 could be available on the mobile device 250, 250′ or be available on a computer 255, which communicates with the CRGS and/or the mobile device 250, 250′. For example, the entry page 400 can appear in display screen 299 or 298. When User-X opens entry page 400, User-X is asked to enter the route destination in field 401 or to select a route destination in field 402. The arrow 403 in field 402 can be pressed to find more selection of destinations. In addition, User-X can also enter a travel start point in field 404, if the start point if different from User-X's current location, or if User-X is planning a trip to be taken in the future. Alternatively, User-X may also click on link 405 of “pick from map” to enter start point and route destination by clicking on locations on a map (not shown).

The entry page 400 may also have a section for route intent entry. For example, User-X can select an intent category from field 406 or create a new intent category in field 407. To create a new category, User-X can enter description of the new category in field 408 and also tags in field 409 to assist the CRGS to process the context of the category better in order to assist User-X in identifying route(s). After information relevant to the new category is entered, User-X can push the “complete” button 410 to add the new category in the intent category list, which is accessible in field 406. User-X can then select the newly created category. In another embodiment, User-X can create new categories without accessing them, but to access them in the future. User-X can just create them for future usage.

User-X can also enter route start and end time by using field 411 and 412. Road condition can vary with start and end time, and also the range of time available for traveling can affect the selection of transportation method. For example, if the range of time specified is not enough for walking to reach the destination, the CRGS should alert User-X.

In addition, entry page 400 can have a section to enter User-X's limitations. For example, User-X can specify User-X is walking by clicking on button 413. User-X can further specify being a slow, medium, or a fast walker. The entry form can provide ranges of speeds for each category, as shown in FIG. 4. In addition, User-X can also specify User-X's range of motion, such as the joint flexibility (for knee and/or ankle) User-X has. User-X can specify he/she has low, medium or high joint flexibility (see FIG. 4). A walker with high joint flexibility can handle hills and valleys, while a walker with low joint flexibility needs a flatter route. Alternatively, User-X can specify that User-X is on wheel chair and the type of wheel chair User-X uses (see FIG. 4). The selections can be made by clicking on the button in front of each category. The selections mentioned above are merely examples, other types of limitation can exist and be used.

Additionally, the entry page can have a field 414 for User-X to enter his/her phobia(s). For example, if User-X specifies that he/she has a phobia of driving on freeway, the CRGS can identify route(s) that does not utilize freeways. Further limitation section of the entry page 400 can have sub-section for User-X to create new limitation(s). User-X can enter the new category of limitation in field 415 and specify the description of the limitation in field 416, and tags for the limitation in field 417. As mentioned above, the description and the tags of new category help the CRGS to better define the context of the category.

In one embodiment, there is a link 419 for changing User-X's profile. When User-X clicks on the link, an entry page would appear to allow User-X to change his/her profile (not shown). The user profile that User-X can change may include many things related to User-X, such as User-X's residence, age, gender, occupation, hobbies, friends and foes, etc. Defining user profile allows the system to better process user's likes and dislikes.

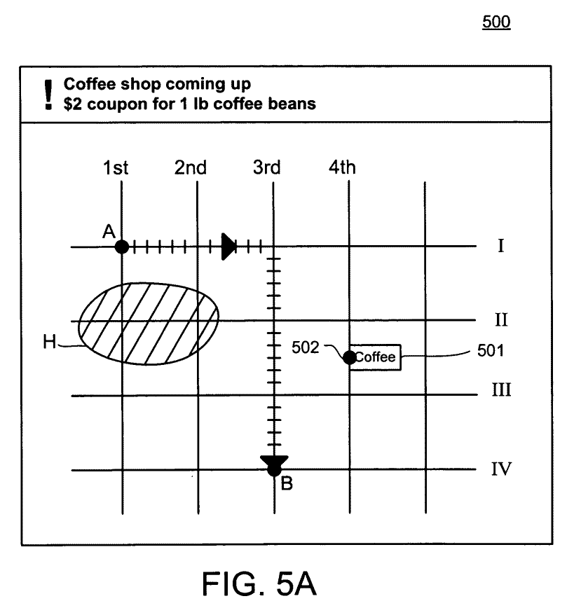

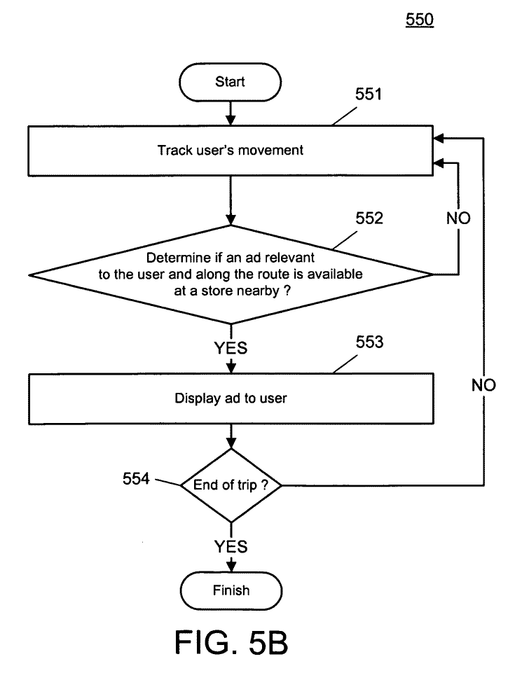

As mentioned above, merchants and businesses can promote their products and services to users of the CRGS. FIG. 5A shows a display 500 of a navigation system, which can be device 250 or 250′ mentioned above, in accordance with one embodiment of the present invention. User-I is walking from location A along the I Street to location B. The route User-I is following is route II, which is similar to route II of FIG. 1. While User-I approaches the intersection of 3^{rd} Street and I Street, the CRGS send an alert to User-I that there is a coffee shop 501 on 4^{th} Street in the neighborhood. The location of the coffee shop 501 can be displayed as a flashing red dot 502 on the display 500. The advertisement (ad) is displayed to User-I because User-I has indicated in his/her profile that User-I like to visit coffee shops. Therefore, the ad is targeted toward User-I based on his/her profile, which is much more effective than random ads. To entice users to visit their coffee shop, coffee shop 501 can provide coupon. In the example in FIG. 5A, in addition to the alert of the coffee shop coming, there is also a $2 coupon for 1 lb coffee beans. By displaying advertisements for businesses along the routes, the owner of the CRGS can collect advertising fees from the advertisers.

FIG. 5B shows a process flow 550 for a CRGS to display advertisement(s) to a user utilizing a navigation system, which is in communication of the CRGS or is integrated with the CRGS, in accordance with one embodiment of the present invention. At operation 551, the CRGS tracks the user's movement (or location) along a route generated by the CRGS. In one embodiment, the user's movement can deviate from the original route and CRGS would update the route to accommodate the user's deviation. At operation 552, the CRGS determines if an advertisement relevant to the user, offered by a business nearby, and along user's route is available If the answer is “yes”, the CRGS displays the relevant ad to the user at operation 553. In one embodiment, in addition to displaying the ad to the user, alerting sound also accompanies the display of ad. If the answer is “no”, the operation continues to operation 554 to determiner if the end of the trip has been reached. If the answer is “no”, the process flow moves from operation 554 to operation 551. Otherwise, the process flow continues to end of the flow. After the ad is displayed to the user at operation 553, the process flow also continues to operation 554.

The CRGS described above stores information relevant to the users and to the route query, and process such information to generate route(s) based on the route query and user's profile. In addition, the CRGS also has the capability of monitoring the movement of the user of the CRGS to update the route. In the mean time, the CRGS will continue mining updated information to provide updated route recommendation to the user, in accordance with one embodiment of the present invention. Further, the CRGS also has the capability of providing advertisement/alert to the user to notify the user of upcoming services that could be of interests to the user.

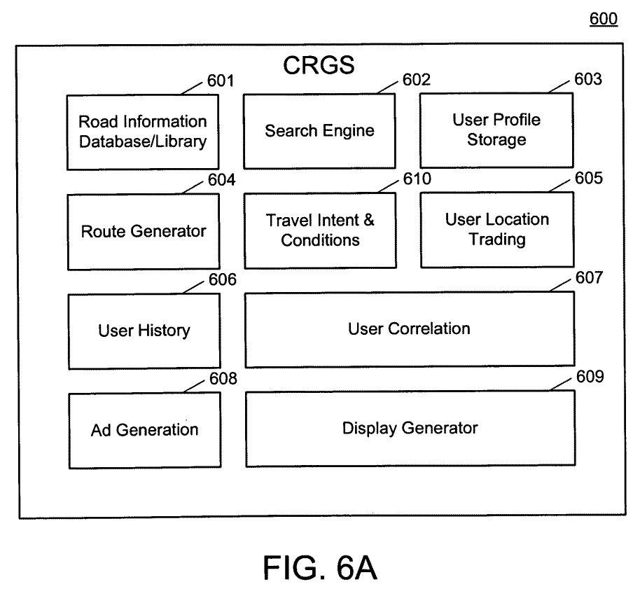

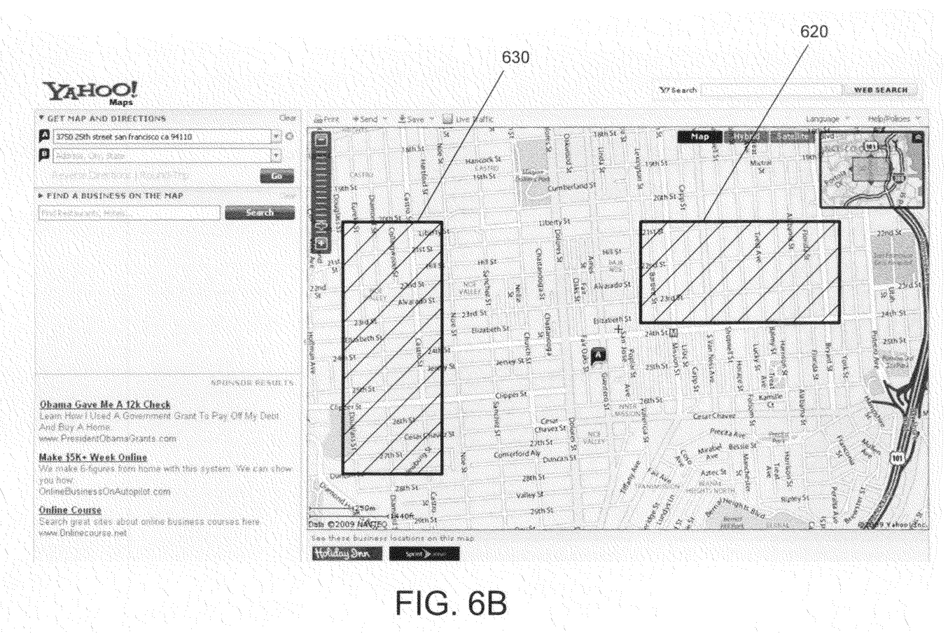

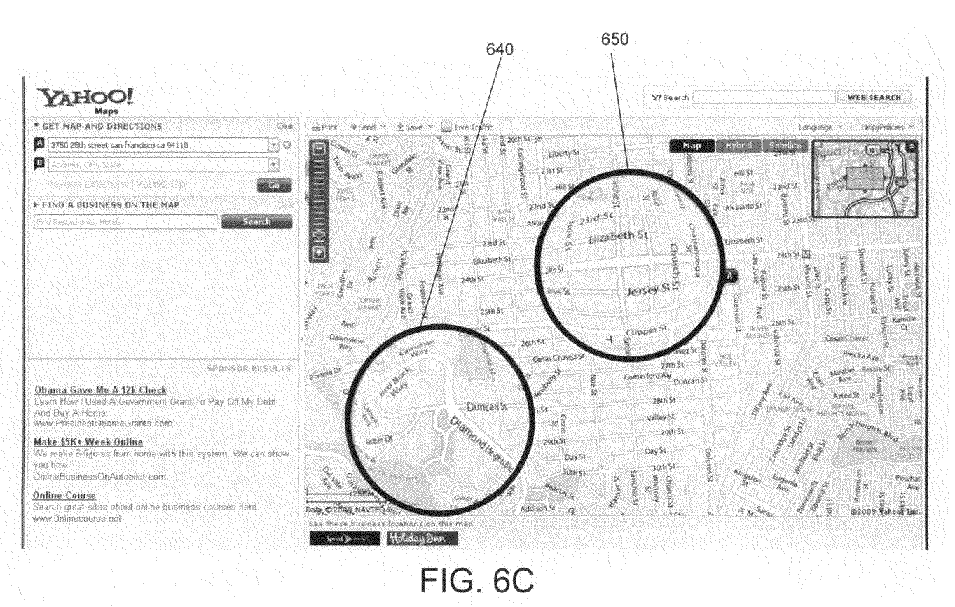

FIG. 6A shows components of a CRGS 600, in accordance with one embodiment of the present invention. The CRGS 600 has a database or library 601 of road information, which store information related to roads, such as the streets, freeways, topography of cities, stores locations, service locations, etc. In addition, the database or library 601 of road information can store the repair schedules of roads, schedules of events and affected areas, crowd information (how crowded certain areas are), traffic patterns, road conditions, etc. All information that would affect the traveling of users can be stored in the database or library 601. In one embodiment, the database or library 601 can be coupled to a search engine (or a related data retriever) 602, which index web sites on the Internet and networks coupled to the Internet, such as W4 COMN, to obtain profile (or historical) and real-time information that are related to trips requested by users. Alternatively, the search engine 602 can reside outside the CRGS and reside in a separate server (not shown).

The CRGS 600 has a storage for user profile 603, which stores information of users of CRGS, such as limitations, conditions, preferences, friends, and etc. of users. In one embodiment, the CRGS 600 accesses additional user profile from W4 COMN, as mentioned above. The information in the user profile 603 may include information for a single user, a number of users, and a few “friends and family” of the user. Alternatively, the user profile 603 can include all users who use CRGS. For example, if the CRGS 200 is integrated with the mobile device 250′, as shown in FIG. 2C, the user profile 603 could include either the user's and a few “friends and family” of the user, in accordance with one embodiment of the present invention. This is due to the relatively limited processing and storage resources available in device 250′, which has the CRGS and the device to display route information. In contrast, if the CRGS 200 is separated by the mobile device 250 traveling with the user, as shown in FIG. 2C, the CRGS can be equipped with a lot more processing and storage resources, in comparison to the device 250′. Alternatively, CRGS can access W4 COMN for more extensive user profiles. In one embodiment, the CRGS 600 has a travel intent and conditions server 610, which stores information related to users' travel intent and conditions. Sever 610 further identifies entities related to the travel intent and conditions. For example, the travel intent server 610 identifies entities, such as the user of trip, the start point of the trip, the end point of the trip, the user's travel companion, time of traveling, means of traveling, etc., based on the travel intent and conditions provided by the user. The entities can be passed to the W4 COMN to extract profile and real-time data related to the entities.

In one embodiment, the CRGS 600 has a route generator (or route generation engine) 604, which utilizes the information in database/library 601, the information in the user profile 603, and information in travel intent storage 610 to generate route(s) most suitable to users' travel intent and conditions (including preferences and needs of users). In one embodiment, the CRGS 600 also access W4 COMN for real-time and profile information relevant to the route request. The W4 engine of the W4 COMN process information relevant to the entities related to the trip request to provide information to the CRGS. The CRGS 600 include the information provided by the W4 COMN to generate route(s) most suitable to users' travel intent and conditions. In one embodiment, the CRGS 600 also has a server 605 for tracking user location (or movement). The server can receive information from a system, such as system 252 in FIGS. 2C and 2D, for tracking the location (or movement) of the user.

In one embodiment, the CRGS 600 has a user history storage 606, which tracks the users' entries, selection of routes, and routes taken in the past. Information stored in the user history storage 606 can also be utilized by the route generator 604 to generate (or recommend) route(s) most suited for users. User history can reveal users' preferences in places, selections made in the past, stores visited, and routes take, etc. In one embodiment, the CRGS 600 has a server 607 for user correlation. As mentioned above, the user profile 603 and the user history storage 606 can store a lot of user information, which can be correlated to generate implicit and supplementary profiles for users. For example, if a user, User-O, who does not enter preferences while using the CRGS, the CRGS can generate a user profile based on the basic information available about User-O. In one embodiment, information in the travel intent storage 610 is also used in correlation in a manner similar to user profile and user profile storage 603, and user history storage 606. For example, the CRGS knows where the navigation system is being used most frequently, such as Palo Alto, Calif., and also knows that User-O is female, and likes to stop for coffee. Based on such information, user correlation can come up with many users who are similar to User-O. The CRGS can recommend advertisements that appeal to people who are similar to User-O. Alternatively, CRGS 600 accesses W4 COMN for user correlation. As mentioned above, W4 COMN tracks many RWEs and IOs. In one embodiment, W4 COMN also tracks users' travel patterns and route selection. Therefore, W4 COMN can provide user correlation information to CRGS.

The CRGS 600 has a server 608 for an advertising engine, in accordance with one embodiment of the present invention. The server 608 serves advertising and can include and ad database to store all activities pertaining to the ad generation and ad display, and an ad processing engine to generate contextually relevant ad(s) based on the route status information from CRGS. In one embodiment, the generated ads match the users' profiles For example, the server 608 generates a shoe store ad for a user walking in a city, since a walker could be interested buying a pair of more comfortable shoes while she/he walks. However, such an ad would not be generated for a user who mostly drives a car, unless the user specifies that he/she wants to visit a shoe store.

In one embodiment, CRGS 600 has a display generator 609, which generates information be to displayed to users. The generated route(s) can be on a map graphic user interface (GUI) or appear as text. For example, the display generator 609 would create screen layout that includes city map and route for a user. The system will present the GUI maps in a manner most relevant to the user. For example, if the route will be used at night, the display generator 609 can generate a map that highlight the route and presents a nighttime terrain view to assist the user. In one embodiment, the display generator 609 also generates display of user's current location. In one embodiment, the display generator 609 also generates display of ads on the mobile device 250, 250′. The displaying of the routes, location and ads is not limited to information displayed on screens of wireless devices 250, 250′. Sound can be added to provide information and alert for users. For example, the CRGS can alert the user that a freeway exit the user needs to take is coming up in 2 miles.

In one embodiment, the mobile device 250 or 250′ has a graphic user interface (GUI) that displays routes at city level and below for vehicles, and for pedestrians on feet or on wheelchair. For users who are hearing-impaired or vision-impaired, displaying the information to such users could be different from regular users. For example, for vision-impaired users, audio displaying could be very important, since the users would need to rely heavily on verbal direction and description. Once the CRGS knows the user is vision-impaired, the CRGS could generate more verbal description to help the user. Similarly for hearing-impaired users, the CRGS would need to rely more on displaying on the screen. The device 250, or 250′ should be able to display icons for the hearing-impaired or provide description, instruction, and alert through sounding means.

In one embodiment, the route maps are editable. For example, users can zoom in and/or out to change the details of the display. In another embodiment, the route maps are schematic. In yet another embodiment, the locations (or areas) of interests are highlighted. FIG. 6B shows two highlighted areas, areas 620 and 630, in a city, which could be useful to users walking or driving at night. Further, the display could represent human geography, for example a place in a city that is very populated can be shown in a larger proportion on the display than a less populated area. Such representation reflects criteria other than simple cartography. FIG. 6C shows two areas, 640 and 650, of a city that are enlarged, such as by a virtual lens, to provide users more details of particular areas.

In addition to regular street maps, terrain maps, the display of routes and locations can also be based on satellite views, which means images of streets and locations taken from the satellites or at street level.

For a navigation system, such as device 250 of FIG. 2C, that utilizes a centralized CRGS that is shared by many users, the user might need to first register with the system to add or edit the user's personal profile (limitations, conditions, and/or preferences), route profile (such as known addresses), and mobile device profile (such as Blackberry™, Apple iPhone™, DashExpress™, etc.) to identify the device for the CRGS device to track and to interact with, etc. As mentioned above, a user can navigate the CRGS system web page via a computer, such as computer 255, or a mobile device (or wireless device), such as device 250, 250′.

As a user walks (or travels) along the route, the system sends updates to the user's registered mobile device if updates are warranted. For example, when a user pulls out her/his mobile device to review the return route, the system will automatically readjust the return route based on current weather and road condition.

In one embodiment, the CRGS system has the following capabilities (or functions):
1: The system keeps track of the user's progress via the user's real time data extracted from the user's mobile device,
2: The system will send alerts to the user if the system finds a route that better fits the user's route conditions,
3: The user can edit or send feedback to the route recommendations,
4: System keeps track of all user choices or edits, and
5: System aggregates user actions to use the information for route prioritization based on route.

As mentioned above, the system can provide alerts of ads based on user's interests, and/or based on available points of interests along the way. For example, the system can alert you that if you have biked up a certain hill, you may want to stop at a vista point on the way to enjoy a view, or you can stop by a coffee shop to get a drink, etc.

In another embodiment, the system can provide extreme routes for people who are looking for adventure, more exercise etc. For example, if User B wants a challenging route to improve heart rate or to train for an upcoming marathon or bicycle race, the user can have the system to find such terrain.

The system with context-sensitive route generation and navigation functions provides routes/maps for users with certain disabilities, limitations, and/or preferences. Local businesses can advertise directly to individuals using the system. Thus, activities by people generate the content, such as traffic conditions, store information, etc., which can be utilized to provide profile and real-time information that is used for route generation. The embodiments of the system will enable very focused, very targeted advertising. Communal participation in data population and data collection on human activities will help keep the data available for the system up to date.

The Context-sensitive Route Generator System (CRGS) generates routes for users that match their travel intent, and current physical, mental, social conditions. CRGS uses explicit and implicit data surrounding the users to generate routes. The system provides interface for users to enter explicit route intent, conditions for physical/mental limitations. The system allows users to add other users as travel companion and allows the travel companion to enter explicit data for route preferences. The system stores and tracks explicit data to develop user route profiles. The system gathers implicit current and past set of temporal, spatial and social data on users incl. travel companions and context surrounding potential routes. CRGS combines the explicit and implicit data to formulate affinity and priority graphs to determine best routes (or most suited routes). CRGS allows users to pick (or select) a route from a list of possible routes.

In one embodiment, the CRGS tracks user's progress en-route and makes real time recommendations based on user's real time data. CRGS has underlying mobile technology that enables it to track the “W4” set of data of the trip and maintains temporal, spatial, social and geographic data on user(s) and the trip based on the location of mobile devices. The W4 information monitoring occurs at all times. In one embodiment, W4 COMN monitors the W4 information related to the trip. CRGS access the W4 COMN to access monitored W4 information related to the trip and adjusts routes when needed.

Some aspects of the CRGS may include, but not limited to:
1) System allows users to enter explicit route conditions/preferences,
2) System tracks information on users and road conditions surrounding users' travel intent and conditions at all times to make adjustments to the route in real time,
3) System automatically makes map interface choices relevant to the user/route, and
4) System displays targeted ads and sends alerts to users to highlight upcoming locations of interests.

With the above embodiments in mind, it should be understood that the invention might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data, which can be thereafter read by a computer system. The computer readable medium may also include an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The above-described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. An electronic device implemented method for generating a route for a trip, comprising:
receiving a request for the trip from a user, the trip defining an origination location and a destination location;
receiving conditions of the trip from the user;
searching a network and system database for profile and real-time data to identify status information related to the user, the request for the trip, and the conditions of the trip;
generating a route for the trip, the route being adjusted based upon the identified status information of the user; and
presenting the route to the user on a display.

2. The electronic device implemented method of claim 1, wherein searching the network including searching a communication network that collects and tracks relationships of real-world entities (RWEs) and information objects (IOs) accessible to the communication network, wherein the relationships of RWEs and IOs tracked by the communication network enable identifying status information related to the user, the request for the trip, and the conditions of the trip.

3. The electronic device implemented method of claim 1, wherein the system database is searched to determine if there is a previously stored route relevant to the trip and conditions.

4. The electronic device implemented method of claim 1, wherein the network is the Internet or a network connected to the Internet.

5. The electronic device implemented method of claim 1, wherein the status information includes at least one of spatial data, temporal data, social data, or topical data related to the user, the trip, and the conditions.

6. The electronic device implemented method of claim 1, wherein the conditions force paths for the route that are indirect of the destination location.

7. The electronic device implemented method of claim 1, wherein the request for the trip includes user's trip intent, and wherein the trip intent includes at least one selected from the group consisting of an identification of the user, the purpose of the trip, the method of transportation, the start and end point of the trip, the time of the trip.

8. The electronic device implemented method of claim 1, wherein the conditions of the trip include at least one selected from the group consisting of physical need, mental need, and social need of the user.

9. The electronic device implemented method of claim 7, wherein the conditions of the trip further include at least one selected from the group consisting of physical need, mental need, and social need of a companion of the user.

10. The electronic device implemented method of claim 1, wherein electronic device implemented method utilizes a context-sensitive route generation system (CRGS) to generate the route for the trip, and wherein the CRGS processes the context of the trip based on the user's trip intent and conditions received from the user and also based on user profile and travel history of the user stored in the CRGS.

11. The electronic device implemented method of claim 10, wherein the CRGS further processes the context of the trip by accessing Internet for user profile and travel history of the user.

12. The electronic device implemented method of claim 11, wherein the real-time status information includes at least one selected from the group consisting of latest road conditions, weather, traffic, and hot spots.

13. An electronic device implemented method for generating a route for a trip, comprising:
receiving a request for the trip from a user, the trip defining an origination location and a destination location;
receiving conditions of the trip from the user;
searching a network and system database for profile and real-time data to identify status information related to the user, the request for the trip, and the conditions of the trip;
generating a route for the trip, the route being adjusted based upon the identified status information of the user;
presenting the route to the user on a display;
receiving real-time status information related to the user, the request for the trip, and the conditions of the trip;
determining if the route needs to be modified based on the real-time status information related to the user, the request for the trip, and the conditions of the trip that is received; and
modifying the route based a change of the real-time status information, otherwise maintaining the route.

14. The electronic device implemented method of claim 13, wherein the change of real-time status information is one of the spatial data, temporal data, social data, or topical data.

15. The electronic device implemented method of claim 13, wherein electronic device implemented method utilizes a context-sensitive route generation system (CRGS), and wherein the CRGS processes the context of the trip based on user profile and travel history of the user stored in the CRGS and available on the Internet.

16. The electronic device implemented method of claim 13, wherein the user's real-time status information includes instant location of the user.

17. The electronic device implemented method of claim 13, further comprising:
displaying an advertisement to the user, wherein the advertisement displayed matches user's profile, the request for the trip, the conditions of the trip, and user's real-time status information.

18. A route generation system for automatically generating a route for a trip based on user's trip intent, conditions of the trip, and status information comprising:
a trip intent and conditions server, wherein the travel intent and conditions server stores the trip intent and the conditions of the trip entered by a user, and wherein the trip intent and conditions server identify entities related to the user, the trip intent, and the conditions;
a database for storing information related to roads and routes;
a search engine for searching and retrieving data from a network and the database for the status information related to entities identified by the trip intent and conditions server;
a route generator configured to generate a route based on the user's trip intent, conditions of the trip, and status information retrieved by the search engine, wherein the route best suits the user's trip intent and conditions of the trip with the status information taken into consideration; and
a display generator configured to display the route generated by the route generator.

19. A route generation system of claim 18, wherein the route generation system is configured to monitor an instant location of the user and is configured to modify an attribute of the generated information display based on at least one of a change of the instant location of the user, a change in the trip intent, a change in the conditions, and a change in the status information identified by the search engine.

20. A route generation system of claim 18, wherein the network is the Internet or a communication network that collects and tracks relationships of real-world entities (RWEs) and information objects (IOs) accessible to the communication network; wherein the communication network is configured to provide profile and real-time information related to the user, the request for the trip, and the conditions of the trip.

21. A route generation system of claim 18, further comprising:
an advertisement engine for generating an advertisement of interest to the user, wherein the advertisement generated is displayed to the user when the use is near a location serving a product or a service described in the advertisement.
